(19) United States
(12) Patent Application Publication
(10) Pub. No.: US 2011/0145549 A1
(43) Pub. Date: Jun. 16, 2011

(54) PIPELINED DECODING APPARATUS AND METHOD BASED ON PARALLEL PROCESSING

(75) Inventors: Jung Hee SUK, Daejeon (KR); Chun Gi Lyuh, Daejeon (KR); Ik Jae Chun, Daejeon (KR); Se Wan Heo, Daejeon (KR); Soon II Yeo, Daejeon (KR); Tae Moon Roh, Daejeon (KR); Jong Kee Kwon, Daejeon (KR); Jong Dae Kim, Daejeon (KR)

(73) Assignee: Electronics and Telecommunications Research Institute, Daejeon (KR)

(21) Appl. No.: 12/862,565

(22) Filed: Aug. 24, 2010

(30) Foreign Application Priority Data
Dec. 15, 2009 (KR) 10-2009-0124366

(51) Int. Cl. G06F 9/30; G06F 9/38

(52) U.S. Cl. 712/208; 712/E09.028; 712/E09.045

(57) ABSTRACT

An apparatus and method for decoding moving images based on parallel processing are provided. The apparatus for decoding images based on parallel processing can improve operational performance by pipelining massive-data transmission between processors while performing context-adaptive variable length decoding (CAVLD), inverse quantization (IQ), inverse transformation (IT), motion compensation (MC), intra prediction (IP) and deblocking filter (DF) operations in parallel in units of pluralities of macroblocks (MBs).

### CROSS-REFERENCE TO RELATED APPLICATION

This application claims priority to and the benefit of Korean Patent Application No. 10-2009-0124366 filed Dec. 15, 2009, the disclosure of which is incorporated herein by reference in its entirety.

### BACKGROUND

1. Field of the Invention

The present invention relates to an apparatus and method for decoding moving images based on parallel processing, and more particularly, to an apparatus and method for decoding images based on parallel processing in which a main processor, a bitstream processor, a parallel-processing array processor and a sequential processing processor are configured for parallel processing, and a transmission time of massive data such as a plurality of macroblocks and an operation between the processors are pipelined through a sequencer processor.

2. Discussion of Related Art

Standards for moving-image compression, such as H.264 AVC and MPEG, adopt various compression tools in which a complex operation is required for a high compression rate and high definition. Generally, the standards define compression tools, which are applied according to required services, as profiles. An encoder and a decoder are implemented according to the profiles. Basic compression tools for a decoder in H.264/AVC include context-adaptive variable length decoding (CAVLD), inverse quantization (IQ), inverse transformation (IT), motion compensation (MC), intra prediction (IP), and deblocking filter (DF), which depend on implementations.

The compression tools are generally implemented by dedicated hardware because the compression tools use complex operation algorithms. For a high-performance personal computer (PC), compression tools may be implemented using software. In the standards, 16×16 pixels for a moving-image screen are defined as a macroblock (MB). A sequential parameter set (SPS), a picture parameter set (PPS), a slice header, a MB header and a MB coefficient value for an input compressed stream are decoded through CAVLD, and then IQ, IT, MC, IP, and DF operations are performed in units of MBs. The operations are iteratively performed on an entire moving-image in units of MBs.

FIG. 1 is a conceptual diagram illustrating a flow of a decoding operation in a pipelining manner using dedicated hardware. As shown in FIG. 1, as variable length decoding (VLD), IQ, IT, MC, IP and DF operations are performed in a pipelining manner in units of MBs, this leads to a higher performance than in sequential operation. However, when a decoding apparatus is implemented using dedicated hardware, defined functions cannot be modified or other functions cannot be added. Accordingly, an implementation of decoding using processor-based software is more advantageous than using dedicated hardware in that the former can support standard modifications or various compression standards.

Meanwhile, since the implementation of decoding using the processor-based software has a lower operational performance than using dedicated hardware, implementations using a parallel processing processor have been studied to improve operational performance. The operational performance can be improved by simultaneously performing the above-described operations on a plurality of MBs, instead of performing the operations on one MB. For example, a parallel-processing array processor having single-instruction multiple-data (SIMD) architecture may be used.

However, the parallel-processing array processor having SIMD architecture performs the same operation on a plurality of data pieces. When there is a correlation that the data pieces cannot be simultaneously subjected to operations, it is difficult to use the parallel-processing array processor. Examples of the H.264/AVC standard include CAVLD, IP, and DF. It is difficult to implement sequential processing of CAVLD, IP, and DF with only the parallel-processing array processor.

### SUMMARY OF THE INVENTION

The present invention is directed to an apparatus and method for decoding images based on parallel processing that are capable of improving operational performance by pipelining massive-data transmission between processors while performing context-adaptive variable length decoding (CAVLD), inverse quantization (IQ), inverse transformation (IT), motion compensation (MC), ultra prediction (IP) and deblocking filter (DF) operations in parallel in units of pluralities of macroblocks (MBs).

The present invention is also directed to an apparatus and method for decoding images based on parallel processing that are capable of achieving efficient parallel processing and minimizing data transmission latency by structuring a main processor, a bitstream processor, a parallel-processing array processor and a sequential processing processor for parallel processing, and by parallel-pipelining a transmission time of massive data such as a plurality of MBs and operations between processors, through a sequencer processor.

One aspect of the present invention provides a pipelined decoding apparatus based on parallel processing, including: a bitstream processor for decoding a sequential parameter set (SPS), a picture parameter set (PPS), a slice header, a MB header and MB coefficient values by performing context-adaptive variable length decoding (CAVLD) on a compressed bitstream; a parallel-processing array processor for simultaneously processing inverse quantization (IQ), inverse transformation (IT) and motion compensation (MC) operations for a plurality of MBs in parallel using the decoded MB header and MB coefficient values; a sequential processing processor for sequentially processing intra prediction (IP) and deblocking filter (DF) operations for the plurality of MBs; a direct memory access (DMA) controller for controlling data transmission for the plurality of MBs between the processors; a sequencer processor for pipelining operations of the processors and data transmission for the plurality of MBs; a main processor for performing initialization of the processors, frame control, and slice control; and a matrix switch bus for connecting among the bitstream processor, the parallel-processing array processor, the sequential processing processor, the DMA controller, the sequencer processor, and the main processor.

Another aspect of the present invention provides a pipelined decoding method based on parallel processing, including: decoding, by a bitstream processor, a header and coefficients for a plurality of MBs; sending the decoded MB header data to a high-speed memory using a DMA controller; structuring and processing, by a main processor, the MB header data stored in the high-speed memory and sending the processed MB header data to a parallel-processing array processor; sending the decoded coefficient values for the plurality of MBs to the parallel-processing array processor using the DMA controller; simultaneously processing, by the parallel-processing array processor, inverse quantization (IQ), inverse transformation (IT) and motion compensation (MC) operations for the plurality of MBs in parallel using the processed MB header data and the coefficient values for the plurality of MBs; sending the plurality of motion-compensated MBs to a sequential processing processor using the DMA controller; and sequentially performing, by the sequential processing processor, intra prediction and deblocking filter operations on the plurality of MBs and sending resultant data to an image frame memory.

### BRIEF DESCRIPTION OF THE DRAWINGS

The above and other objects, features and advantages of the present invention will become more apparent to those of ordinary skill in the art by describing in detail exemplary embodiments thereof with reference to the attached drawings, in which:

FIG. 1 is a conceptual diagram illustrating a flow of a decoding operation in a pipelining manner using dedicated hardware;

FIG. 2 is a conceptual diagram illustrating a flow of parallel-processing a decoding operation in units of M×N MBs according to an exemplary embodiment of the present invention;

FIG. 3 is a block diagram of an apparatus for decoding an image based on parallel processing according to an exemplary embodiment of the present invention;

FIG. 4 is a block diagram of a bitstream processor according to an exemplary embodiment of the present invention;

FIG. 5 is a block diagram of a parallel-processing array processor according to an exemplary embodiment of the present invention;

FIG. 6 is a block diagram of a sequencer processor according to an exemplary embodiment of the present invention; and

FIG. 7 illustrates an example of data transmission and a control method for each processor for implementing a pipeline by parallel-processing M×N MBs.

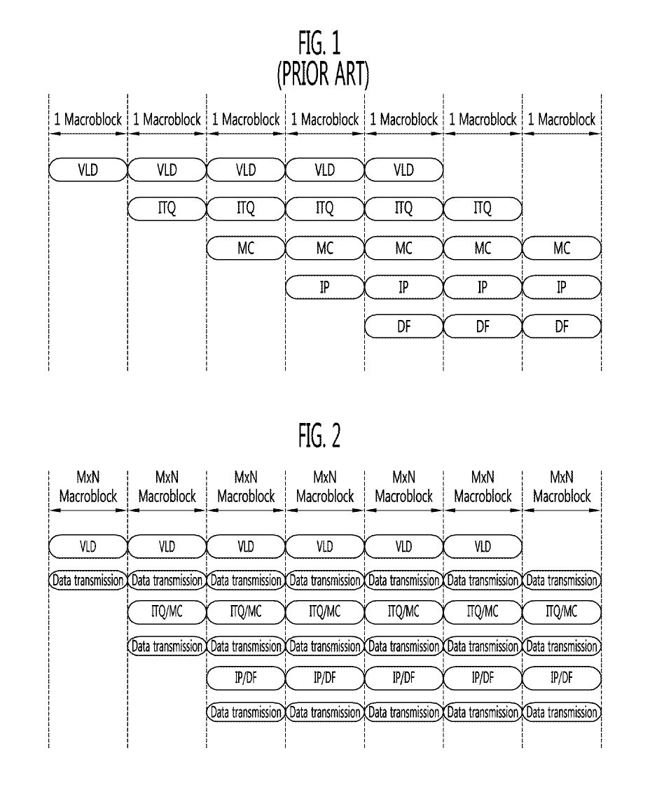

### DETAILED DESCRIPTION OF EXEMPLARY EMBODIMENTS

Hereinafter, exemplary embodiments of the present invention will be described in detail. However, the present invention is not limited to the embodiments disclosed below but can be implemented in various forms. The following embodiments are described in order to enable those of ordinary skill in the art to embody and practice the present invention. To clearly describe the present invention, parts not relating to the description are omitted from the drawings. Like numerals refer to like elements throughout the description of the drawings.

Throughout this specification, when an element is referred to as “comprises,” “includes,” or “has” a component, it does not preclude another component but may further include the other component unless the context clearly indicates otherwise. Also, as used herein, the terms “ . . . unit,” “ . . . device,” “ . . . module,” etc., denote a unit of processing at least one function or operation, and may be implemented as hardware, software, or combination of hardware and software.

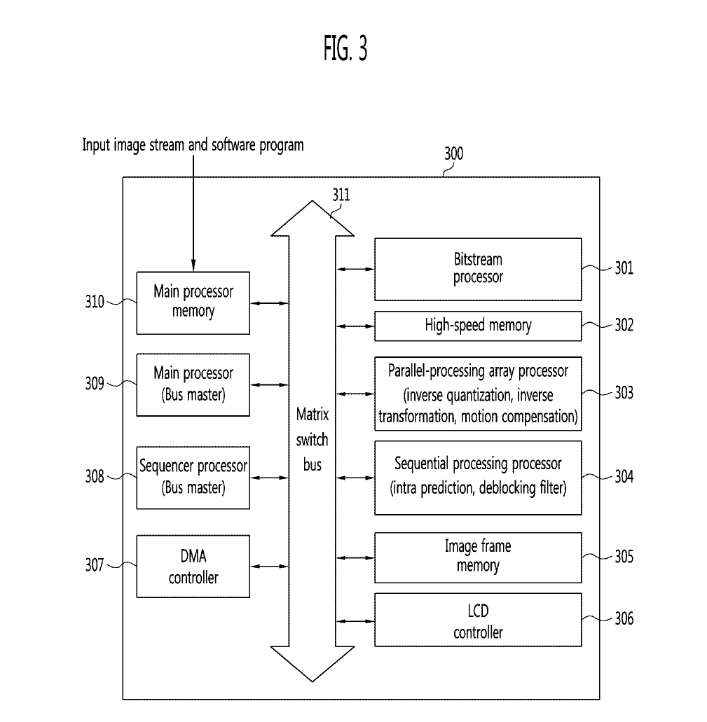

FIG. 2 is a conceptual diagram illustrating a flow of parallel-processing a decoding operation in units of M×N macroblocks (MBs) according to an exemplary embodiment of the present invention. As shown in FIG. 2, when the parallel data throughput of a parallel-processing array processor corresponds to M×N MBs, context-adaptive variable length decoding (CAVLD), inverse quantization (IQ), inverse transformation (IT), motion compensation (MC), ultra prediction (IP) and deblocking filter (DF) operations are performed in parallel in units of M×N MBs, and simultaneously, transmission of massive data corresponding to the M×N MBs between processors is pipelined to improve the performance.

Hereinafter, a configuration and a control scheme of a decoding apparatus for improving operational performance according to the present invention will be described in greater detail with reference to FIGS. 3 to 7.

FIG. 3 is a block diagram of an apparatus for decoding images based on parallel processing according to an exemplary embodiment of the present invention. Referring to FIG. 3, an image decoding apparatus 300 includes a bitstream processor 301, a high-speed memory 302, a parallel-processing array processor 303, a sequential processing processor 304, an image frame memory 305, a liquid crystal display (LCD) controller 306, a direct memory access (DMA) controller 307, a sequencer processor 308, main processor 309, a main processor memory 310, and a matrix switch bus 311.

The bitstream processor 301 sequentially performs CAVLD on compressed bitstreams stored in the main processor memory 310 to decode a SPS, a PPS, a slice header and a MB header and MB coefficient values for M×N MBs. The bitstream processor 301 sends the decoded SPS, PPS, slice header and MB header to the high-speed memory 302 and the decoded MB coefficient values to a memory of the parallel-processing array processor 303. The data sent to the high-speed memory 302 is structured and processed by the main processor 309 and sent to the memory of the parallel-processing array processor 303. The bitstream processor 301 sends the decoded MB coefficient values to the parallel-processing array processor and simultaneously decodes next M×N MBs.

The parallel-processing array processor 303 performs IQ, IT, and MC operations on the M×N MBs using header data (e.g., a mode, a quantization value, a motion vector, etc.) of the M×N MBs processed by the main processor 309 and the MB coefficient values received from the bitstream processor 301.

Meanwhile, since data cannot be simultaneously processed due to their correlation in some operations, it is difficult to use the parallel-processing array processor 303. Accordingly, the sequential processing processor 304 is required to sequentially process the IP and DF operations in units of blocks/MBs. The sequential processing processor 304 sequentially processes the IP and DF operations in units of MBs to process the IP and DF operations on the M×N MBs. The sequential processing processor 304 sequentially processes the IP and DF operations, but includes a memory for receiving and storing residual data for the M×N MBs from the parallel-processing array processor 303 and storing M×N MBs that are decoded through IP and DF operations, for pipeline of an overall operation of the decoding apparatus. When an exception in which the processor operation is terminated or is not terminated within a determined execution time occurs, the sequential processing processor 304 generates an interrupt signal. The interrupt signal is input to an interrupt controller of the main processor or an interrupt controller of the sequencer processor.

The image frame memory 305 stores the decoded image frame data.

The LCD controller 306 performs display control under control of the main processor 309.

The DMA controller 307 controls massive-data transmission for the M×N MBs among the bitstream processor 301, the high-speed memory 302, the parallel-processing array processor 303, the sequential processing array processor 304, and the image frame memory 305.

The sequencer processor 308 performs control so that the data transmission of the DMA controller 307 and the operation of the above-described processors can be pipelined. In order to pipeline the operation of each processor and the data transmission in units of any M×N MBs, the sequencer processor 308 operating on a pipeline control program is necessary. The sequencer processor 308 according to the present invention may serve as a master of the matrix switch bus and access the parallel-processing array processor 304, the sequential processing processor 305 and a control register of the DMA controller 307 to control each processor, and may pipeline the operation of each processor and the data transmission using the DMA controller.

The main processor 309 serves as a bus master of the matrix switch bus 311 and performs other operations, such as initialization of each processor, frame control, slice control, and processing and decoding of the SPS, the PPS, the slice header and the MB header.

The main memory 310 stores an input image stream and a software program required for decoding.

The matrix switch bus 311 is a data and instruction delivery path for connecting among the processors and the memories.

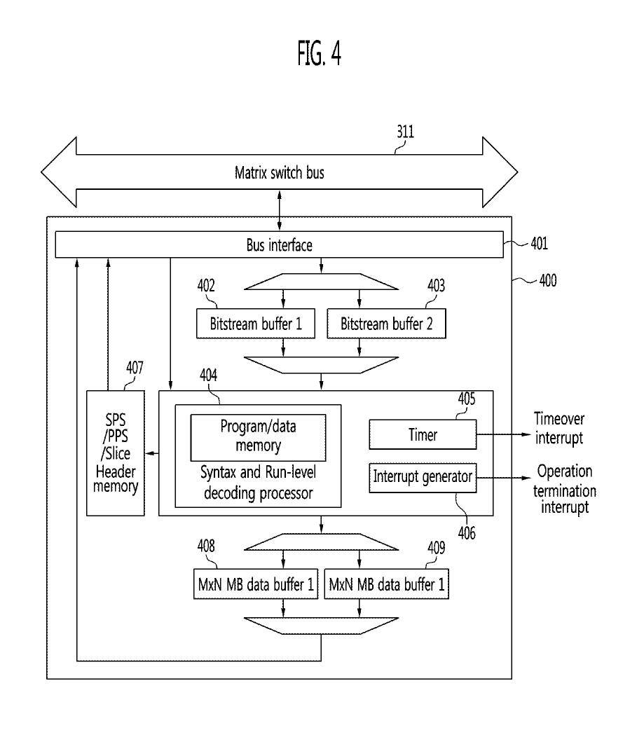

FIG. 4 is a block diagram of a bitstream processor according to an exemplary embodiment of the present invention. A bitstream processor 400 has a structure in which the bitstream processor 400 can receive bitstreams while performing a decoding operation by storing the bitstreams in two input buffers and continuously output the decoded coefficient values of the M×N MBs by storing the decoded coefficient values of the M×N MBs in two output buffers, in order to maximize the performance of the parallel-processing array processor that parallel-processes the M×N MBs.

Specifically, the bitstream processor 400 includes a bus interface 401, first and second bitstream buffers 402 and 403, a decoding processor 404, a timer 405, an interrupt generator 406, a memory 407, and first and second M×N MB data buffers 408 and 409.

The bus interface 401 communicates between the matrix switch bus 311 and internal components of the bitstream processor 400. The first and second bitstream buffers 402 and 403 store image bitstreams received via the bus interface 401. The first and second bitstream buffers 402 and 403 are implemented as two buffers so that bitstream receiving and decoding operations can be simultaneously performed.

The decoding processor 404 stores a program and a variable length decoding (VLD) table required for variable length decoding in an internal memory, decodes the bitstreams stored in the first and second bitstream buffers 402 and 403, outputs a SPS, a PPS, a slice header and a MB header, stores the SPS, the PPS, the slice header and the MB header in the memory 407, and stores coefficient values for the M×N MBs in the first and second M×N MB data buffers 408 and 409. Use of the first and second M×N MB data buffers 408 and 409 enables the coefficient values to be stored and output continuously.

The timer 405 measures an execution time of the processor and generates a timeover interrupt signal to indicate that time is over. The timeover interrupt signal is generated when the operation of the processor is not terminated within a determined execution time due to occurrence of an exception in the processor. When the operation of the bitstream processor is terminated, the interrupt generator 406 generates an operation termination interrupt signal. The generated interrupt signal is delivered to an interrupt controller of the main processor 309 or an interrupt controller of the sequencer processor 308.

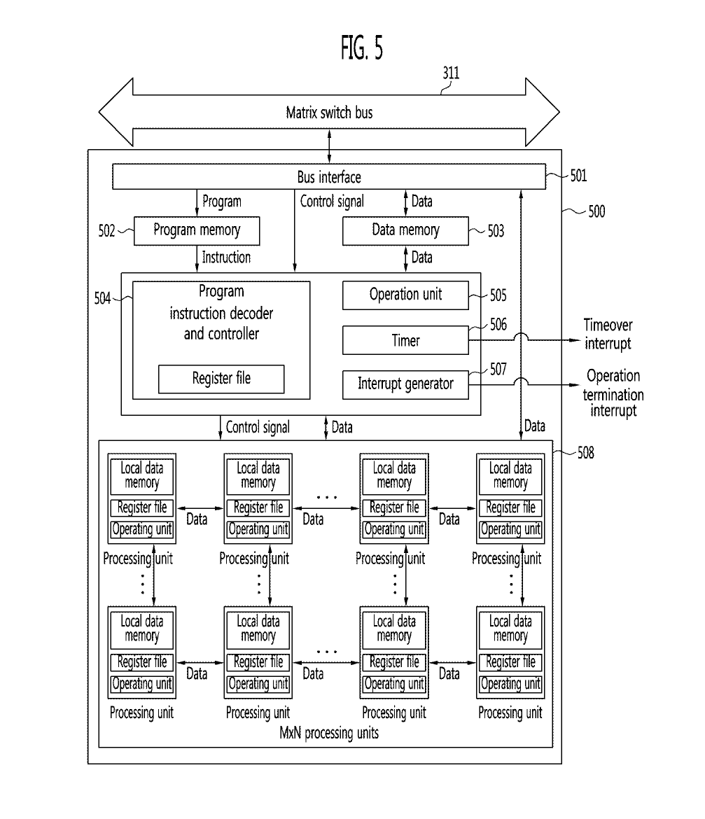

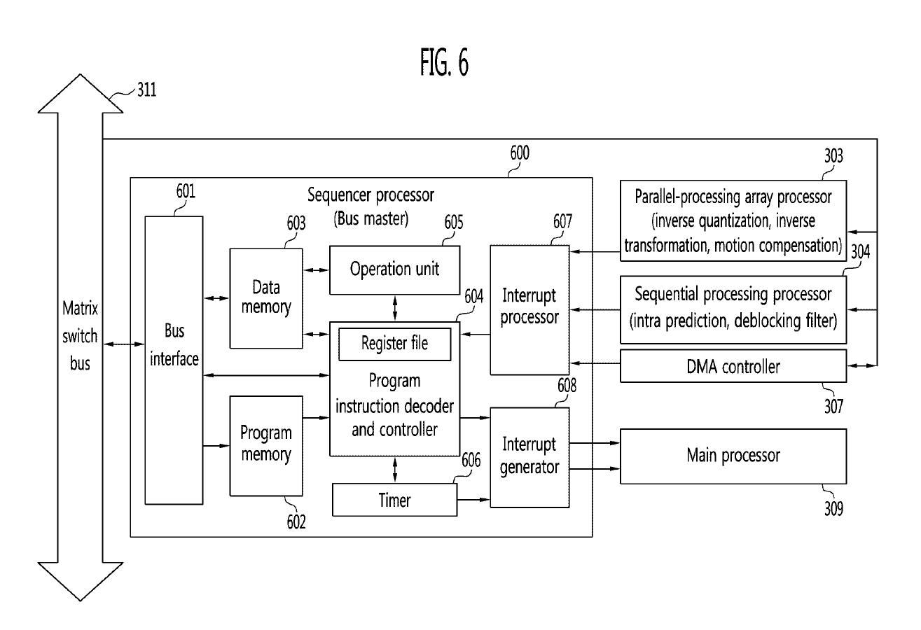

FIG. 5 is a block diagram of a parallel-processing array processor according to an exemplary embodiment of the present invention. Referring to FIG. 5, a parallel-processing array processor 500 includes a bus interface 501 for communicating between the matrix switch bus 311 and internal components of the parallel-processing array processor 500, a program memory 502 for storing a program for performing IQ, IT, and MC operations on M×N MBs, a data memory 503 for storing data used in common by M×N processing units or data required for control, and the M×N processing units 508.

Each of the M×N processing units 508 includes a local data memory for receiving coefficient values for M×N MBs from the M×N MB data buffer of the bitstream processor via the DMA controller to store the coefficient values, and receiving reference data required for MC operation from the image frame memory via the DMA controller to store the reference data. The local data memory includes a dual port memory in order to receive data from the exterior via the DMA controller or transmit the data to the exterior while loading/storing data required for internal operations, such that the operation and the data transmission can be pipelined. The parallel-processing array processor 500 further includes a program instruction decoder and controller 504, an operation unit 505 for performing data operation, a timer 506 for measuring an execution time of the processor and generating a timeover interrupt indicating that time is over, and an interrupt generator 507 for generating an operation termination interrupt signal when an operation of the parallel-processing array processor is terminated. The interrupt signal is sent to the interrupt controller of the main processor or the interrupt controller of the sequencer processor.

Although each of the M×N processing units 508 can basically process one allocated MB, the M×N processing unit may process 4×4 allocated pixel blocks or a plurality of allocated MBs according to a memory size and a need upon implementation. The M×N processing units 508 have a data exchange path in a net structure. The M×N processing units 508 operate in SIMD architecture to process instructions of the controller 504 in parallel.

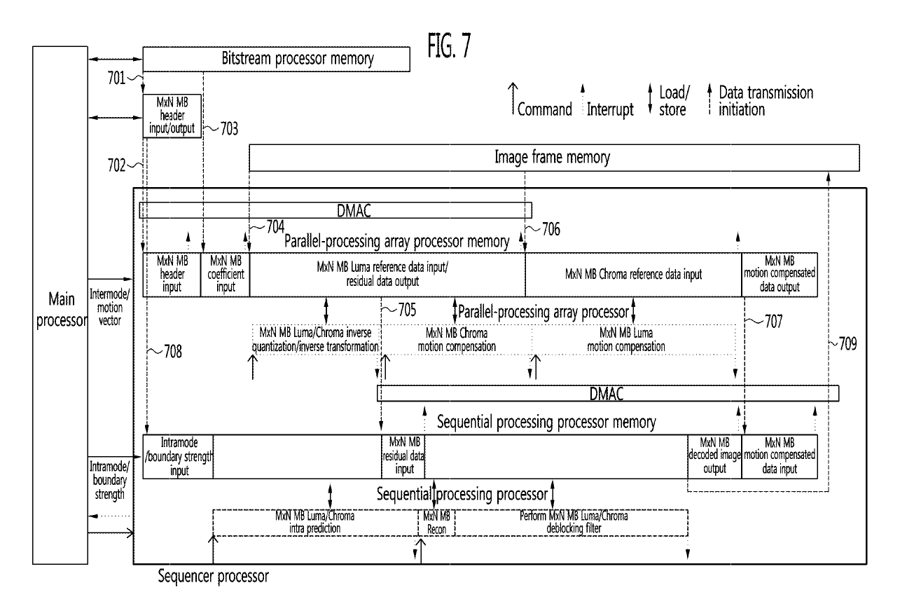

FIG. 6 is a block diagram of a sequencer processor according to an exemplary embodiment of the present invention. The main processor cannot perform all of data transmission between the processors required for pipeline control, processing of interrupts generated by each processor and control of each processor, while performing other operations for frame control, slice control, display control, and decoding. When the decoding apparatus is implemented by a processor-based software program, rather than dedicated hardware, there is no defined operation cycle for pipelining, and a cycle required for pipeline control is randomly changed due to randomness of the performance of a program or a bus, the performance of the DMA controller, and a unit of a MB processed in parallel. Accordingly, a sequencer processor operating on a program for pipeline control is necessary to pipeline operation of each processor and data transmission in units of any M×N MBs. The sequencer processor according to the present invention may serve as a master of the matrix switch bus and access the parallel-processing array processor, the sequential processing processor and the control register of the DMA controller to control each of them, and may pipeline the data transmission among them through DMA controller setup.

Referring to FIG. 6, the sequencer processor 600 includes a bus interface 601 for interfacing between the matrix switch bus 311 and internal components of the sequence processor, a program memory 602 for storing a program required to pipeline the operation of each processor and the data transmission, a data memory 603 for storing related data, a program instruction decoder and controller 604, an operation unit 605 for performing a required address operation, and a timer 606 for measuring an execution time of the sequencer processor. The sequencer processor 600 further includes an interrupt processor 607 for processing interrupts generated by the parallel-processing array processor 303, the sequential processing processor 304, and the DMA controller 307, and an interrupt generator 608 for generating an interrupt when an operation of the sequencer processor is terminated or is not terminated within a determined execution time.

FIG. 7 illustrates an example of data transmission and a control method for each processor for implementing a pipeline by processing M×N MBs in parallel. It will be easily understood by those skilled in the art that the example shown in FIG. 7 is of illustrative purpose and the data transmission and the control method may vary with the performance of implemented processors, the performance of a memory, an operation frequency, the performance of a bus, etc.

Referring to FIG. 7, command transmissions by the main processor or the sequencer processor are indicated by unidirectional solid arrows, transmissions of an interrupt generated by each processor are indicated by dotted arrows, data load and store are indicated by bidirectional arrows, and data transmissions between the memories are indicated by dashed arrows.

Specifically, the SPS, the PPS, the slice header, and the MB header decoded by the bitstream processor are sent to the high-speed memory via the DMA controller (701), and are structured and processed by the main processor. The processed header data (a mode, a quantized value, a motion vector, etc.) of the M×N MBs are sent from the high-speed memory to the parallel-processing array processor memory (702).

Meanwhile, the coefficient values of the M×N MBs decoded by the bitstream processor are sent to the memory of the parallel-processing array processor (703). When the coefficient values of the M×N MBs are being sent to the memory of the parallel-processing array processor via the DMA controller, the bitstream processor continuously decodes coefficient values of next M×N MBs.

The parallel-processing array processor performs IQ and IT operations, in parallel, on the M×N MBs using the input MB header value and coefficient value, and simultaneously stores reference data for luma/chroma from the image frame memory in the memory of the parallel-processing array processor (704). Residual data generated by the parallel-processing array processor that has performed the IQ and IT operations is sent to the sequential processing processor memory (705). The parallel-processing array processor stores the reference data for remaining luma/chroma in the memory of the parallel-processing array processor (706) and simultaneously performs IT.

When the operations for the M×N MBs are terminated, data of M×N motion-compensated MBs is sent to the sequential processing processor memory under control of the DMA controller (707).

Meanwhile, when the operation of the bitstream processor is initiated, intramode and boundary strength values are sent from the high-speed memory or the main processor to the sequential processing processor memory (708), which performs IT. When the IT is terminated, the prediction value is added to the residual data and a clip operation is performed to generate data of the decoded M×N MBs. A DF operation is performed on the decoded M×N MBs and resultant data is sent to the image frame memory (709).

The execution control of each processor and the data transmission via the DMA controller described above are performed according to a pipeline control program stored in the program memory of the sequencer processor. Also, the sequencer processor processes the interrupt generated by each processor and an interrupt generated when the DMA controller performs data transmission and completes the transmission. When the operation performed on the M×N MBs by the sequencer processor is terminated, a termination interrupt is sent from the sequencer processor to the interrupt controller of the main processor. Subsequently, the main processor drives a next pipeline stage in units of M×N MBs, and initiates decoding of next M×N MBs.

As shown in FIG. 7, according to the present invention, when decoding of moving images is implemented, the pipeline capable of performing the CAVLD, IQ, IT, MC, IP and DF operations in parallel in units of M×N MBs using the bitstream processor, the parallel-processing array processor, the sequential processing processor and the main processor, and capable of processing data transmission between the processors and the operation of the processors in parallel is implemented, thereby achieving efficient parallel processing of decoding and minimizing data transmission latency.

According to the present invention, in order to implement a decoding apparatus based on parallel processing in units of M×N MBs that is capable of achieving a higher operational performance than sequential operations for one MB, a main processor, a bitstream processor, a parallel-processing array processor, and a sequential processing processor are structured for parallel processing, and a transmission time of massive data such as M×N MBs and each operation of the processors are parallel-pipelined through the sequencer processor, thereby improving overall operational performance.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A pipelined decoding apparatus based on parallel processing, the apparatus comprising:
a bitstream processor for decoding a sequential parameter set (SPS), a picture parameter set (PPS), a slice header, a macroblock (MB) header and MB coefficient values by performing context-adaptive variable length decoding (CAVLD) on a compressed bitstream;
a parallel-processing array processor for simultaneously processing inverse quantization (IQ), inverse transformation (IT) and motion compensation (MC) operations for a plurality of MBs in parallel using the decoded MB header and MB coefficient values;
a sequential processing processor for sequentially processing intra prediction (IP) and deblocking filter (DF) operations for the plurality of MBs;
a direct memory access (DMA) controller for controlling data transmission for the plurality of MBs between the processors;
a sequencer processor for pipelining operations of the processors and data transmission for the plurality of MBs;
a main processor for performing initialization of the processors, frame control, and slice control; and
a matrix switch bus for connecting among the bitstream processor, the parallel-processing array processor, the sequential processing processor, the DMA controller, the sequencer processor, and the main processor.

2. The apparatus of claim 1, further comprising a high-speed memory for storing the decoded SPS, PPS, slice header and MB header for the bitstream, wherein the main processor structures and processes the SPS, PPS, slice header and MB header stored in the high-speed memory and sends the processed MB header to the parallel-processing array processor.

3. The apparatus of claim 1, wherein the decoded MB coefficient values for the bitstream are sent to the parallel-processing array processor by the DMA controller.

4. The apparatus of claim 1, further comprising an image frame memory for storing data decoded by the bitstream processor, the parallel-processing array processor and the sequential processing processor.

5. The apparatus of claim 1, wherein the bitstream processor comprises:
two input buffers for storing the compressed bitstream received via the matrix switch bus to continuously receive the bitstream simultaneously with operation of the bitstream processor; and
two output buffers for storing the decoded MB coefficient values to continuously output the MB coefficient values to the parallel-processing array processor.

6. The apparatus of claim 1, wherein the bitstream processor comprises an interrupt generator for generating an interrupt signal when an operation of the bitstream processor is terminated or an exception occurs, and sending the generated interrupt signal to the sequencer processor or the main processor.

7. The apparatus of claim 4, wherein the parallel-processing array processor comprises:
a program memory for storing a program for performing the IQ, IT, and MC operations;
a data memory for storing the MB coefficient values received from the bitstream processor and receiving and storing reference data required for the MC operation from the image frame memory;
a plurality of processing units for simultaneously processing the IQ, IT, and MC operations for the plurality of MBs; and
an interrupt generator for generating an interrupt signal when operation of the parallel-processing array processor is terminated or an exception occurs and sending the generated interrupt signal to the sequencer processor or the main processor.

8. The apparatus of claim 7, wherein the parallel-processing array processor simultaneously performs the IQ, IT, and MC operations for the plurality of MBs and reception of the reference data required for the MC operation from the image frame memory.

9. The apparatus of claim 8, wherein the reference data required for the MC operation from the image frame memory is sent to the data memory of the parallel-processing array processor by the DMA controller.

10. The apparatus of claim 7, wherein the MC operation is performed while residual data obtained by the parallel-processing array processor completing the IQ and the IT is being sent to the sequential processing processor by the DMA controller.

11. The apparatus of claim 7, wherein data motion-compensated by the parallel-processing array processor is sent to the sequential processing processor by the DMA controller.

12. The apparatus of claim 1, wherein the sequencer processor accesses the parallel-processing array processor, the sequential processing processor and a control register of the DMA controller to control initiation and termination of operations of the processors, and pipelines the operations of the processors and data transmission using the DMA controller.

13. The apparatus of claim 1, wherein the sequencer processor comprises:
a program memory for storing a control program for pipelining the operation of each processor and the data transmission; and
a data memory.

14. The apparatus of claim 1, wherein the sequencer processor comprises:
an interrupt processor for processing interrupts generated by the parallel-processing array processor, the sequential processing processor and the DMA controller; and
an interrupt generator for generating an interrupt when the operation of the sequencer processor is terminated or is not terminated within a determined execution time.

15. The apparatus of claim 14, wherein the main processor initiates decoding of a plurality of next MBs when receiving the interrupt indicating that the operation is terminated from the sequencer processor.

16. The apparatus of claim 1, wherein the sequential processing processor sequentially processes the IP and DF operations in units of MBs to complete the IP and DF operations for the plurality of MBs.

17. A pipelined decoding method based on parallel processing, the method comprising:
decoding, by a bitstream processor, a header and coefficients for a plurality of macroblocks (MBs);
sending the decoded MB header data to a high-speed memory using a DMA controller;
structuring and processing, by a main processor, the MB header data stored in the high-speed memory and sending the processed MB header data to a parallel-processing array processor;
sending the decoded coefficient values for the plurality of MBs to the parallel-processing array processor using the DMA controller;
simultaneously processing, by the parallel-processing array processor, inverse quantization (IQ), inverse transformation (IT) and motion compensation (MC) operations for the plurality of MBs in parallel using the processed MB header data and the coefficient values for the plurality of MBs;
sending the plurality of motion-compensated MBs to a sequential processing processor using the DMA controller; and
sequentially performing, by the sequential processing processor, ultra prediction and deblocking filter operations on the plurality of MBs and sending resultant data to an image frame memory.

18. The method of claim 17, wherein the bitstream processor decodes coefficient values for a plurality of next MBs while the decoded coefficient values for the plurality of MBs are being sent to the parallel-processing array processor using the DMA controller.

19. The method of claim 17, wherein the simultaneously processing of the IQ, IT and MC operations comprises:
simultaneously performing the IQ and IT and transmission of some of reference data for luma/chroma from the image frame memory to a memory of the parallel-processing array processor; and
simultaneously performing transmission of residual data obtained by performing the IQ and IT to a memory of the sequential processing processor and the MC operation.

20. The method of claim 17, wherein the method is performed according to a control signal of a sequencer processor for executing a program to control operations of the parallel-processing array processor, the sequential processing processor and the DMA controller.
